(19) United States
(12) Patent Application Publication
(10) Pub. No.: US 2023/0066320 A1
(43) Pub. Date: Mar. 2, 2023

(54) AUTOMATED MACHINE LEARNING FOR PRE-TRAINING

(71) Applicant: RIIID INC., Seoul (KR)

(72) Inventors: Dong Min SHIN, Seoul (KR); Ho yean SONG, Seoul (KR)

(73) Assignee: RIIID INC., Seoul (KR)

(21) Appl. No.: 17/890,946

(22) Filed: Aug. 18, 2022

(30) Foreign Application Priority Data
Aug. 20, 2021 (KR) 10-2021-0109866

(51) Int. Cl. G06N 20/00

(52) U.S. Cl. CPC G06N 20/00

(57) ABSTRACT

In the present specification, a method of performing pre-training using an automated machine learning (AutoML) model by a server includes: using a first model for performing a first task to generate a second model for a second task; inputting, to the Auto ML model, a preset feature based on 1) components of the first model and the second model and 2) an element obtainable from training of the first model and generating of the second model as a state value; and changing the first model using the AutoML model.

### CROSS-REFERENCE TO RELATED APPLICATION

This application claims priority to and the benefit of Korean Patent Application No. 10-2021-0109866, filed on Aug. 20, 2021, the disclosure of which is incorporated herein by reference in its entirety.

### BACKGROUND

### 1. Field of the Invention

The present specification relates to a method of applying automated machine learning (AutoML) for training a pre-training model to maximize the performance of a target task in pre-training of an artificial intelligence (AI) model, and an apparatus for the same.

### 2. Discussion of Related Art

Meta-learning refers to an artificial intelligence (AI) system that learns by itself only with given data and an environment. Through meta-learning, an AI model may apply previously learned information and algorithms to a new problem to solve the problem.

As an example of a meta-learning method, automated machine learning (AutoML) is a method that automatically selects a human selection in a process of conventional machine learning. For example, AutoML may include hyper parameter optimization (HPO), neural architecture search (NAS), or the like. The goal of such AutoML is to maximize the performance for a given task, and to investigate a search range more efficiently compared to human selection, thereby reducing the cost for achieving the performance.

More specifically, to make data usable for machine learning, experts may apply data pre-processing, feature engineering, feature extraction, and feature selection.

After such operations, in order to maximize the predictive performance of a model, experts may select an algorithm and perform hyperparameter optimization. AutoML may simplify the above operations in the case of a non-expert.

### SUMMARY OF THE INVENTION

The present invention is directed to providing a pre-training method using an AutoML model.

In addition, the present invention is directed to providing an efficient pre-training method using an AutoML model to which a reinforcement learning algorithm is applied.

The technical objectives of the present invention are not limited to the above, and other objectives may become apparent to those of ordinary skill in the art based on the following descriptions.

According to an aspect of the present invention, there is provided a method of performing pre-training using an automated machine learning (AutoML) model by a server, the method including: using a first model for performing a first task to generate a second model for a second task; inputting, to the Auto ML model, a preset feature based on 1) components of the first model and the second model and 2) an element obtainable from training of the first model and generating of the second model as a state value; and changing the first model using the AutoML model.

The method may further include: generating the second model using the first model changed using the AutoML model; and transmitting a compensation value to the AutoML model based on a performance of the second model.

The method may further include training the AutoML model based on the compensation value.

The compensation value may have a positive number when the performance of the second model is improved compared to the previous performance of the second model, and have a negative number when the performance of the second model is lowered compared to the previous performance of the second model.

The changing of the first model may include: obtaining an action value for training the first model from the AutoML model; and inputting, to the first model, the action value to train the first model.

The action value may be an element that may be required to be set in the first model to train the first model.

The element may include a type of a task of the first model, a learning level of the first model, a structure of the first model or a hyperparameter value for the first model.

The first model may be a combination of pre-training models with a best performance based on a plurality of pre-training models.

In addition, the combination of the pre-training models is based on a setting value that is preset in the server, and the setting value may include performance information about the combination of the plurality of pre-training models.

According to an aspect of the present invention, there is provided a server for performing pre-training through an automated machine learning (AutoML) model, the server including: a memory; and a processor, wherein the processor may be configured to: train a first model for performing a first task and generate a second model for a second task using the first model; input, to the Auto ML model, a preset feature based on 1) components of the first model and the second model and 2) an element obtainable from the training of the first model and generating of the second model as a state value; and change the first model using the AutoML model.

The technical solutions of the present specification are not limited to the above, and other solutions may become apparent to those of ordinary skill in the art based on the following description.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating an electronic device related to the present specification;

FIG. 2 is a block diagram illustrating an artificial intelligence (AI) apparatus according to an embodiment of the present specification;

FIG. 3 is an example of a machine learning procedure applicable to the present specification;

FIG. 4 is an example of a random search to which the present specification is applicable;

FIG. 5 is an example of reinforcement learning to which the present specification is applicable;

FIG. 6 is an embodiment to which the present specification is applicable; and

FIG. 7 is an example of an ensemble method to which the present specification is applicable.

The accompanying drawings, which are included as a part of the detailed description to aid understanding of the present specification, provide embodiments of the present specification, and together with the detailed description, explain the technical features of the present specification.

### DETAILED DESCRIPTION OF EXEMPLARY EMBODIMENTS

Hereinafter, embodiments of the present specification will be described in detail with reference to the accompanying drawings. In the drawings, parts identical to those throughout the drawings will be assigned the same number, and redundant descriptions thereof will be omitted. The suffixes for elements used in the following description “module,” “part,” and “unit” have only been assigned or used together in consideration of the ease of drafting and do not have distinct meanings or roles by themselves. In the description of the embodiments, detailed descriptions of related known techniques will be omitted to avoid obscuring the subject matter of the present disclosure. In addition, the accompanying drawings are used to aid in the understanding of the embodiments of the present specification, and are not intended to limit the technical spirit of the present specification, and cover all modifications, equivalents, and alternatives falling within the spirit and scope of the present specification.

It should be understood that, although terms including ordinal numbers, such as first, second, etc., may be used herein to describe various elements, these elements are not limited by these terms. These terms are only used to distinguish one element from another element.

It should be understood that, when an element is referred to as being “connected to” or “coupled to” another element, the element can be directly connected or coupled to another element, or intervening elements may be present. Conversely, when an element is referred to as being “directly connected to” or “directly coupled to” another element, there are no intervening elements present.

As used herein, the singular forms “a,” “an,” and “one” are intended to include the plural forms as well, unless the context clearly indicates otherwise.

It should be further understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

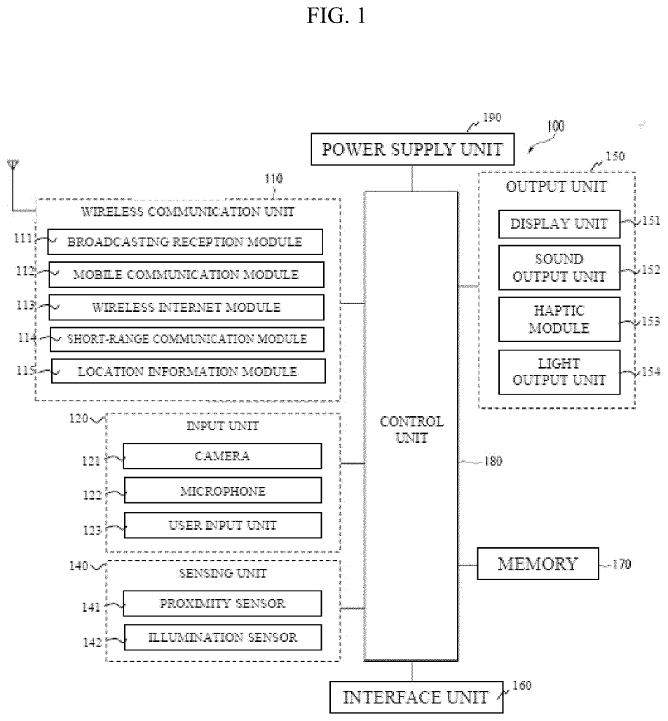

FIG. 1 is a block diagram illustrating an electronic device related to the present specification.

The electronic device 100 may include a wireless communication unit 110, an input unit 120, a sensing unit 140, an output unit 150, an interface unit 160, a memory 170, a control unit 180, a power supply unit 190, and the like. The components shown in FIG. 1 are not essential in implementing the electronic device 100, and thus, the electronic device 100 described herein may have more or fewer components than those listed above.

More specifically, the wireless communication unit 110 among the components may include one or more modules that enable wireless communication between the electronic device 100 and a wireless communication system, between the electronic device 100 and another electronic device 100, or the electronic device 100 and an external server. In addition, the wireless communication unit 110 may include one or more modules for connecting the electronic device 100 to one or more networks.

The wireless communication unit 110 may include at least one of a broadcast reception module 111, a mobile communication module 112, a wireless Internet module 113, a short-range communication module 114, and a location information module 115.

The input unit 120 may include a camera 121 or an image input unit for inputting an image signal, a microphone 122 or an audio input unit for inputting an audio signal, and a user input unit 123 for receiving information from a user, for example, a touch key, a push key, etc. Voice data or image data collected by the input unit 120 may be analyzed and processed as a control command of a user.

The sensing unit 140 may include one or more sensors for detecting at least one type of information among information inside the electronic device 100, surrounding environment information around the electronic device 100, and user information. For example, the sensing unit 140 may include at least one of a proximity sensor 141, an illumination sensor 142, a touch sensor, an acceleration sensor, a magnetic sensor, a gravity sensor (a G-sensor), a gyroscope sensor, a motion sensor, a red-green-blue (RGB) sensor, an infrared (IR) sensor, a fingerprint recognition sensor (a finger scan sensor), an ultrasonic sensor, an optical sensor (e.gl, a camera (denoted by 121), a microphone (denoted by 122), a battery gauge, an environmental sensor (e.g., a barometer, a hygrometers, a thermometer, a radiation detection sensor, a thermal sensor, a gas sensor, etc.) and a chemical sensor (e.g., an electronic nose, a healthcare sensor, a biometric sensor, etc.). Meanwhile, the electronic device disclosed in the present specification may combine information detected by at least two of the sensors and use the combined information.

The output unit 150 is provided to generate an output related to a visual sense, an auditory sense, or a tactile sense, and may include at least one of a display unit 151, a sound output unit 152, a haptic module 153, and an optical output unit 154. The display unit 151 may implement a touch screen by forming a mutual layer structure with a touch sensor or by being formed integrally with a touch sensor. Such a touch screen may serve as the user input unit 123 for providing an input interface between the electronic device 100 and the user, while providing an output interface between the electronic device 100 and the user.

The interface unit 160 serves as a passage with various types of external devices connected to the electronic device 100. The interface unit 160 may include at least one of a wired/wireless headset port, an external charger port, a wired/wireless data port, a memory card port, a port for connecting a device equipped with an identification module, an audio I/O (Input/Output) port, a video I/O port, and an earphone port. The electronic device 100 may, in response to an external device being connected to the interface unit 160, perform appropriate control related to the connected external device.

In addition, the memory 170 may store data for supporting various functions of the electronic device 100. The memory 170 may store a plurality of application programs (or applications) run in the electronic device 100, data for operation of the electronic device 100, and commands for operation of the electronic device 100. At least some of the application programs may be downloaded from an external server through wireless communication. In addition, at least some of the application programs may be present on the electronic device 100 from the time of shipment for basic functions (e.g., call sending and receiving functions, message receiving and sending functions) of the electronic device 100. Meanwhile, the application program may be stored in the memory 170, installed on the electronic device 100, and run by the control unit 180 to perform an operation (or a function) of the electronic device 100.

In addition to the operation related to the application program, the control unit 180 generally controls the overall operation of the electronic device 100. The control unit 180 may process signals, data, information, etc. input or output through the above-described components, or run an application program stored in the memory 170 to provide or process information or functions appropriate for the user.

In addition, the control unit 180 may, in order to run the application program stored in the memory 170, control at least some of the components described with reference to FIG. 1. Furthermore, the control unit 180 may, in order to run the application program, operate at least two of the components included in the electronic device 100 in combination with each other.

The power supply unit 190 receives external power and internal power under the control of the control unit 180 to supply power to each component included in the electronic device 100. The power supply unit 190 includes a battery, and the battery may be a built-in battery or a replaceable battery.

At least some of the components may operate cooperatively to implement an operation, control, or control method of the electronic device according to various embodiments described below. In addition, the operation, control, or control method of the electronic device may be implemented on the electronic device by running at least one application program stored in the memory 170.

In the present specification, the electronic device 100 may be collectively referred to as a terminal.

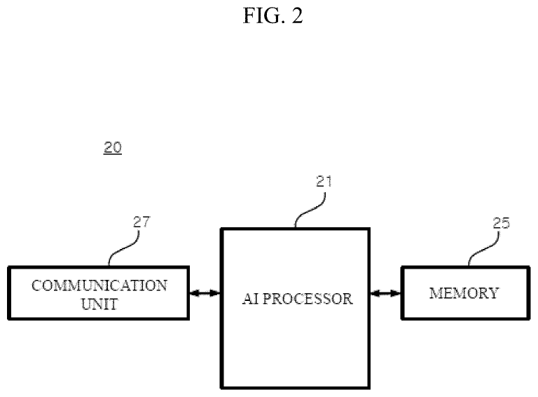

FIG. 2 is a block diagram illustrating an artificial intelligence (AI) apparatus according to an embodiment of the present specification.

The AI apparatus 20 may include an electronic device including an AI module capable of performing AI processing, or a server including the AI module. In addition, the AI apparatus 20 may be included as at least a part of the electronic device 100 shown in FIG. 1 to perform at least a part of AI processing together with the electronic device 100.

The AI apparatus 20 may include an AI processor 21, a memory 25 and/or a communication unit 27.

The AI apparatus 20 is a computing device capable of training a neural network, and may be implemented in various electronic devices, such as a server, a desktop personal computer (PC), a notebook PC, a tablet PC, and the like.

The AI processor 21 may train a neural network using a program stored in the memory 25. In particular, the AI processor 21 may generate an automated machine learning (AutoML) model that performs a function of designing a pre-training model to increase the performance of a target model.

On the other hand, the AI processor 21 that performs the above described function may be a general-purpose processor (e.g., a central processing unit (CPU)), or may be an AI-only processor (e.g., a graphics processing unit (GPU)) for AI learning.

The memory 25 may store various programs and data required for the operation of the AI apparatus 20. The memory 25 may be implemented as a non- volatile memory, a volatile memory, a flash-memory, a hard disk drive (HDD), or a solid-state drive (SDD). The memory 25 may be accessed by the AI processor 21, and reading/writing/modifying/deleting/updating of data by the AI processor 21 may be performed in the memory 25. In addition, the memory 25 may store a neural network model (e.g., a deep learning model) generated through a learning algorithm for data classification/recognition according to an embodiment of the present specification.

Meanwhile, the AI processor 21 may include a data learning unit that trains a neural network for data classification/recognition. For example, the data learning unit may obtain training data to be used for training and apply the obtained training data to a deep learning model, thereby training the deep learning model.

The communication unit 27 may transmit a result of the AI processing by the AI processor 21 to an external electronic device.

Here, the external electronic device may include other terminals and servers.

Meanwhile, although the AI apparatus 20 shown in FIG. 2 has been described as functionally divided into the AI processor 21, the memory 25, the communication unit 27, and the like, the above-described components may be integrated into one module and referred to as an AI module or an AI model.

In the present specification, pre-training may be training performed on an AI model before training of the AI model for a task to be originally performed. Pre-training has been developed as a technique performed before being applied to a new task having a small amount of data, to improve the performance of an AI model, but studies have shown that it is effective to perform pre-training regardless of the type of the task and then perform main training. For example, pre-training is most active in the field of natural language processing (NLP), and representative models include bidirectional encoder representations from transformers (BERT), generative pre-trained transformer (GPT)-3, and the like.

For example, an AI model that performs a sentence generation function may be subject to training by outputting a sentence through an input value required for sentence generation, and comparing the output sentence with an existing correct answer. However, when the pre-training method is used, a pre-training model may be subject to training by masking a part of a sentence and using a task of predicting the masked word. The pre-training model trained as described above may generate a target model that performs a sentence generation task. For example, the pre-training model may be changed to a model for the original target task, and the changed pre-training model may be subject to training for the original task through an input value required for sentence generation. Alternatively, the pre-training model may be used for training of a model for the original task.

For example, a pre-training model is not for performing a pre-training task, but for generating a target model. Therefore, it is important to find a pre-training model that maximizes the performance of the target model. However, in the pre-training method, a pre-training model is generated, a target model is generated through the pre-training model, and the performance of the target model is measured on a target task to finally evaluate the performance of the pre-training model, which takes a great deal of time.

On the other hand, the conventional AutoML mainly performs a search for hyperparameters of a model, a structure of a model, or data features. However, in order to apply a pre-training method to model construction, a search needs to be performed for construction of a pre-training model that maximizes the performance of the target task. The search may include the type of a pre-training task, the level of pre-training, the structure of the model, and hyperparameters of the pre-training model.

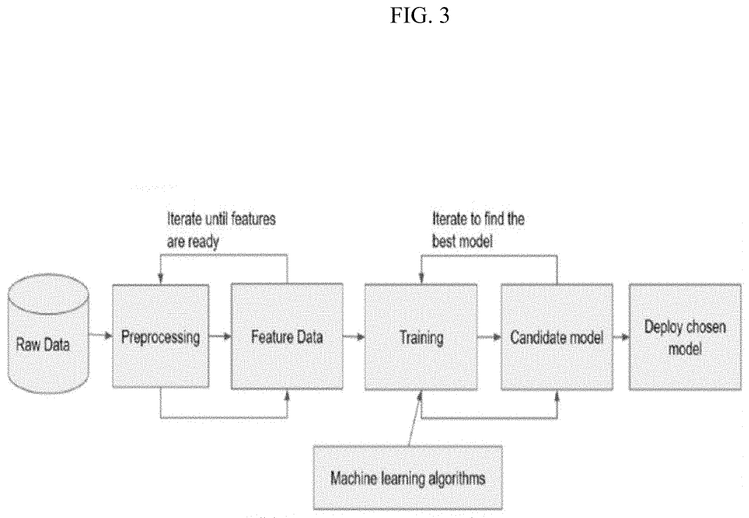

FIG. 3 is an example of a machine learning procedure applicable to the present specification.

Referring to FIG. 3, AutoML is a machine learning method of maximally automating inefficient tasks that occur whenever a machine learning procedure is performed by repetition of procedures so that the productivity and efficiency are increased. AutoML may target various procedures in the machine learning procedure. For example, AutoML may automate procedures, such as data preprocessing, feature engineering, model selection, and result analysis.

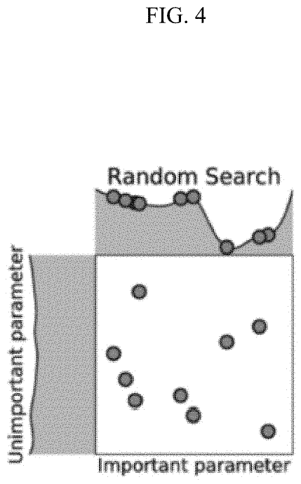

FIG. 4 is an Example of a Random Search for Optimizing Hyperparameters

Hyperparameters required in machine learning (e.g., the depth of layers constituting the model, the number of filters included in each layer, learning rate, batch size, etc.) need to be specified by an expert. Since the optimal variable values of such variables are different for each data set, the expert needs to repeat numerous experiments to find the optimal hyperparameters.

Referring to FIG. 4, a random search for optimizing hyperparameters is illustrated. For example, the random search is a method in which, among values in a section where an optimal value is expected to be present, a value is randomly selected by checking a value with high accuracy. In more detail, in order to use the random search efficiently, an appropriate range need to be set first. In addition, a parameter having a high correlation with a result value may be preferentially subject to the optimization process.

When a target task is a score prediction, an input value of an AI model for performing the task is a problem solving sequence written by the user, and a result value may be a predicted score. In order to improve the performance of the AI model, various methods of pre-training may be considered. In this case, an AutoML model may use a random search for the pre-training.

For example, AutoML may be used to determine a type of a pre-training task, a level of pre-training (e.g., the number of times of pre-training, a learning rate, etc.), and a hyperparameter and a model structure for the determined pre-training model. To this end, the user may set an appropriate range.

Table 1 is an example of the range set by the user described above.

TABLE 1

| Setting elements | Ranges |
|---|---|
| Types of pre-training task | task 1 (e.g., a task of guessing an |
| | original value of a masked part of an |
| | input value) |
| | task 2 (e.g. a task of guessing whether |
| | the order of discrete input values has |
| | been reversed) |
| Level of pre-training | The number of times of training: 1 to 10 |
| | Learning rate: 0.001 to 0.1 |
| model structure | Transformer, Transformer Encoder, long |
| | short-term memory (LSTM) |
| Hyperparameter | The number of encoder layers: 2 to 6 |

Referring to Table 1, the user sets the range, and through a random search, a pre-training method with the best performance of the target task may be determined. Table 1 is an example to which the present specification is applicable, and it should be understood that a range similar to the above may be included in the range for a random search.

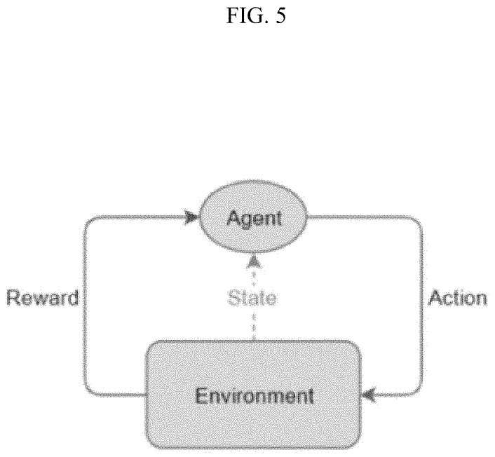

FIG. 5 is an example of reinforcement learning to which the present specification is applicable.

Referring to FIG. 5, reinforcement learning is a learning method with feedback about whether machine learning is appropriate. For example, when a model performing learning is referred to as an agent, and the agent performs an action while interacting with an environment, a positive reward or a negative penalty may be assigned according to the action. More specifically, it may emphasized to the agent as to how the agent needs to act in a particular episode in order to receive a maximum as an expected value for the sum of rewards.

The above-described random search, which is a method of automating a human action, does not significantly reduce the actual search time. Therefore, the present specification proposes a method of using a reinforcement learning model for an AutoML model.

Referring again to FIG. 5, for example, an agent may include an AutoML model. The AutoML model may serve to design a pre-training model such that the performance of a target model is maximized.

In FIG. 5, an environment may include data that may be generated while the pre-training model is performing training for the target model. In more detail, the environment may include data related to the pre-training model and the target model, and may include, for example, a gradient of the pre-training model, a gradient of the target model, and the like.

A state is an input value input to the agent, and may include data that may be obtained in the environment described above. For example, a feature that is preset in the environment may be selected as a state. In more detail, the feature may be set as data for improving the performance of the agent. For example, the gradient of the pre-training model and the gradient of the target model may be selected as a state.

A reward may be given according to the amount of change in the performance of the target model generated through the pre-training model when compared to the previous step. For example, a positive reward may be given when the performance has increased, and a negative reward may be given when the performance has decreased.

With such a configuration, the AutoML model may perform an action of designating the ranges of the elements of Table 1 above to increase the performance of the target model. For example, the action may include elements set by humans for training of a pre-training model.

The server may train the AutoML model in a direction of maximizing an expected value of Return, which is the sum of rewards even including future rewards in a given state, through reinforcement learning. Through the reinforcement learning, the server may efficiently designate pre-training values according to the state of the pre-training.

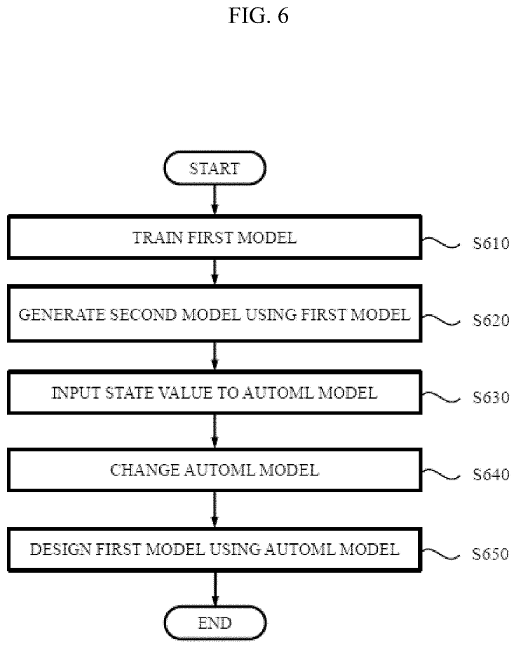

FIG. 6 is an embodiment to which the present specification is applicable.

Referring to FIG. 6, the server may include an AutoML model, a target model, and a pre-training model for training the target model. The initial AutoML model is in an untrained state and may be set with an initial value.

### First Embodiment

The server trains a first model (S610). The first model may include a pre-training model. For example, the first model may be a pre-training model for pre-training a target model which has sentence generation as a target task. In this case, the task of the pre-training model may be to guess a masked word. The server may train the first model based on the task of the first model. For example, the initial pre-training model may be trained at a set learning rate (e.g., 0.001).

The server generates a second model using the first model (S620). For example, the second model may be the target model to be subjected to pre-training. The target model may have a different task from that of the pre-training model. For example, the server may train the target model through the trained pre-training model or change the pre-training model to the target model. For example, a target model trained through an initial pre-training model may achieve a performance of 90%.

The server inputs, to the AutoML model, a preset feature based on 1) components of the first model and the second model, and 2) elements obtainable in the training of the first model and the generation of the second model as a state value (S630). For example, the server may input the gradient of the first model and the gradient of the second model to the AutoML model as a state. In more detail, the state value may be selected as data for improving the performance of the AutoML model among pieces of data related to the first and second models.

The server uses the AutoML model to change the first model (S640). For example, the server may change the first model by performing an action for changing hyperparameters of the first model by the AutoML model. The server may input the gradient of the first model and the gradient of the second model after the action to the AutoML model as a state, and input a reward to the AutoML model based on the performance of the second model. With such a configuration, the AutoML model may be trained to set hyperparameters of the first model that maximize the performance of the second model based on the received reward. The AutoML model may be set to have a learning rate (e.g., 0.01) different from the learning rate of the pre-training model. The server designs the first model using the trained AutoML model (S650). For example, the AutoML model may change a first task of the first model to a third task to generate a third model as a pre-training model. The server may use the third model to generate a second model for performing the target task. The server may measure the performance of the second model, and transmit a reward value to the AutoML model according to the measured performance. When the performance of the second model is improved, the trained AutoML model may be changed to more likely select the third task than the first task as a pre-training task based on the reward value.

For example, the reward value may have a positive value when the performance of the second model is improved compared to the performance of the second model in the previous step, and may have a negative value when the performance of the second model is lowered compared to the performance of the second model in the previous step.

### Second Embodiment

The server may perform the above-described first embodiment a predetermined number of times. In this case, the server may train the AutoML model according to the sum of the reward values.

### Third Embodiment

The server may perform the first embodiment and the second embodiment several times to further advance the AutoML model. For example, the server may perform operations of the first and second embodiments a predetermined number of times, or may perform operations of the first and second embodiments until the performance of the AutoML exceeds a certain level.

### Fourth Embodiment

The server may, after the operations of the above-described first embodiment, second embodiment, and/or third embodiment, obtain an action value for training the first model from the AutoML, and input the action value to the first model, to thereby train the first model. For example, the action value may correspond to an action of reinforcement learning, and may be an element required to be set in the pre-training model. The elements may include a type of a task of the first model, a level of training of the first model, a structure of the first model, or hyperparameter values for the first model. The first model trained through the AutoML model may be used to generate the second model for solving the target task.

The existing pre-training have more elements required to be selected by humans when compared to general models, and thus requires high development costs. However, the pre-training method using the AutoML model proposed in the present specification may allow a machine, rather than a human, to optimize the performance thereof, thereby minimizing the waste of human resources. In addition, the pre-training method uses a reinforcement learning algorithm, thereby contributing to raising the maximum efficiency even with a limited GPU and time.

### Fifth Embodiment

In machine learning, an ensemble method is a method of generating an accurate ensemble model by combining several models. In the ensemble method, there may be an infinite number of cases in combining various models.

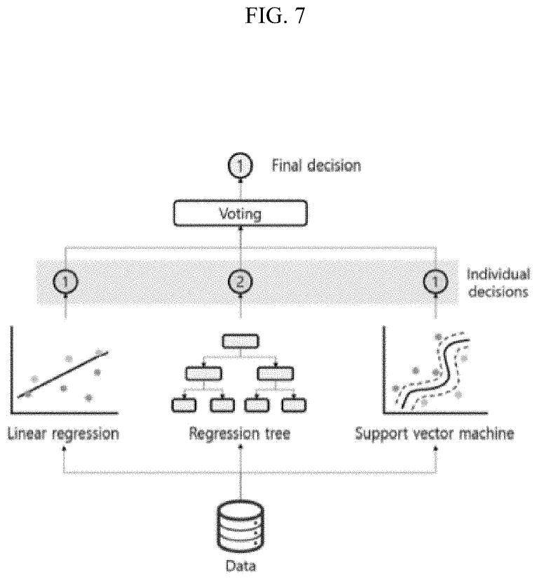

FIG. 7 is an example of an ensemble method to which the present specification is applicable.

Referring to FIG. 7, base estimators are combined based on voting to generate a final estimator. For example, in the vote-based ensemble method, since predictions of a majority provide a final prediction, a value of 1 instead of 2 may be selected as the final prediction in FIG. 7. However, since the final error rate may rather increase when an estimator with a very low accuracy is combined, the present specification may employ not only an ensemble method using voting, but also an ensemble method using a combination using a maximum/minimum value or an average value.

As such, in the ensemble method for combining various models, the number of cases that is rapidly increased depending on the number of models and the number of combinations. In this case, in order to find an appropriate combination, an efficient search technique is required.

For example, when the ensemble method is applied to the pre-training method using the above described AutoML model, it may take a long time for each number of cases in which the pre-training models are combined.

To solve the limitation, the server may train a plurality of the first models in operation S610. The server may store an inference result of the first task for the plurality of first models. The server may measure the performance of ensemble models, in which the plurality of first models are combined, based on the stored inference result. The above operations may be performed off-line, and the server may return an ensemble model with the best performance as the first model in operation S620. In this case, the server may replace the operations for the first model from operation S620 of the first embodiment to the fourth embodiment with the operations for the returned ensemble model.

For example, the first model may be a combination of pre-training models with the best performance based on the plurality of pre-training models, and the combination of the pre-training models is based on a setting value that is preset in the server, and the setting value may include performance information about the combination of the plurality of pre-training models.

With such a configuration, the server may generate an ensemble model with better performance at a lower cost.

The present specification described above may be embodied as computer-readable code on a program recording medium. The computer-readable medium includes all types of storage devices configured to store data that can be read by a computer system. Examples of the computer-readable medium include a HDD, a solid-state drive (SSD), an SDD, a read-only memory (ROM), a random-access memory (RAM), a compact disc (CD)-ROM, a magnetic tape, a floppy disk, an optical data storage device, and the like. In addition, the computer-readable medium may be implemented in the form of a carrier wave (e.g., transmission through the Internet).

Further, the above description is to be considered illustrative rather than restrictive in all aspects. The scope of the specification is to be determined by a reasonable interpretation of the appended claims, and the present specification covers all modifications provided they come within the scope of the appended claims and their equivalents.

According to an embodiment of the present specification, pre-training capable of minimizing the waste of human resources using an AutoML model can be performed.

In addition, according to an embodiment of the present specification, pre-training with maximum efficiency can be performed using an AutoML model to which a reinforcement learning algorithm is applied.

The effects of the present specification are not limited to those described above, and other effects not described above will be clearly understood by those skilled in the art from the above detailed description.

Although the present specification has been described with reference to services and embodiments, it should be understood by those skilled in the art that the embodiments disclosed above should be considered not for the purpose of limitation and various modifications and applications that are not illustrated above are possible without departing from the essential characteristics of the present embodiments. For example, each component specifically shown in the embodiment may be implemented with modification. Differences related to such modifications and applications should be understood as being included in the scope of the present specification defined in the appended claims.

What is claimed is:

1. A method of performing pre-training using an automated machine learning (AutoML) model by a server, the method comprising:
using a first model for performing a first task to generate a second model for a second task;
inputting, to the Auto ML model, a preset feature based on 1) components of the first model and the second model and 2) an element obtainable from training of the first model and generating of the second model as a state value; and
changing the first model using the AutoML model.

2. The method of claim 1, further comprising:
generating the second model using the first model changed using the AutoML model; and
transmitting a compensation value to the AutoML model based on a performance of the second model.

3. The method of claim 2, further comprising training the AutoML model based on the compensation value.

4. The method of claim 3, wherein the compensation value has a positive number when the performance of the second model is improved compared to the previous performance of the second model, and has a negative number when the performance of the second model is lowered compared to the previous performance of the second model.

5. The method of claim 3, wherein the changing of the first model includes:
obtaining an action value for training the first model from the AutoML model; and
inputting, to the first model, the action value to train the first model.

6. The method of claim 5, wherein the action value is an element that is required to be set in the first model to train the first model.

7. The method of claim 6, wherein the element includes a type of a task of the first model, a learning level of the first model, a structure of the first model or a hyperparameter value for the first model.

8. An apparatus that is a server for performing pre-training through an automated machine learning (AutoML) model, the apparatus comprising:
a memory; and
a processor,
wherein the processor is configured to:
train a first model for performing a first task and generate a second model for a second task using the first model;
input, to the Auto ML model, a preset feature based on 1) components of the first model and the second model and 2) an element obtainable from the training of the first model and generating of the second model as a state value; and
change the first model using the AutoML model.

9. The apparatus of claim 8, wherein the processor is configured to generate the second model using the first model changed using the AutoML model, and transmit a compensation value to the AutoML model based on a performance of the second model.

10. The apparatus of claim 9, wherein the processor is configured to train the AutoML model based on the compensation value.

11. The apparatus of claim 10, wherein the processor is configured to obtain an action value for training the first model from the AutoML model, and input the action value to the first model to train the first model.

12. The method of claim 5, wherein the first model is obtained, based on a plurality of pre-training models, as a combination of the pre-training models with a best performance.

13. The method of claim 12, wherein the combination of the pre-training models is obtained, based on a setting value that is set in advance in the server, and the setting value includes performance information about a combination of the plurality of pre-training models.
